(19) United States
(12) Patent Application Publication
(10) Pub. No.: US 2003/0054784 A1
(43) Pub. Date: Mar. 20, 2003

(54) Infrared full-duplex wireless communication device

(76) Inventors: Fredrick C. Conklin, Mountain View, CA (US); Cornelia M. Truong, Palo Alto, CA (US)

Correspondence Address: MCKENNA LONG & ALDRIDGE LLP, 1900 K STREET, NW, WASHINGTON, DC, 20006, US

(21) Appl. No.: 09/954,003

(22) Filed: Sep. 18, 2001

(51) Int. Cl. H04B 5/00

(52) U.S. Cl. 455/151.2; 455/41

(57) ABSTRACT

A full duplex infrared wireless communication device is disclosed for use with any of a plurality of electronic devices. The system includes a remote unit and a base. The device is adaptable to be used with any of a plurality of devices, including cellular, portable and landline telephones. The base unit electrically connects with the electronic device to adapt signals from the electronic device for transmitting to the remote unit via a first infrared wavelength. The remote unit transmits signals to the base unit on a second infrared wavelength. When used with a telephone, the remote unit includes a headset with a speaker, a microphone, and data processing circuitry to receive digital signals on the first infrared wavelength and to transmit digital signals on the second infrared wavelength.

### BACKGROUND OF THE INVENTION

1. Field of the Invention

The present invention relates to a full-duplex wireless communication device, and more particularly, to an infrared full-duplex wireless headset having use in a number of fields, including cellular telephone, landline telephones, computer devices, televisions, audio equipment, and various other household or commercial products that may be controlled remotely.

2. Discussion of the Related Art

The use of portable communication and electronic devices has become widespread in recent years. Among the most popular of these devices is the cellular telephone. The number of consumers using cellular telephones has dramatically increased in a very short period of time. However, there are serious safety concerns that have developed in conjunction with the rapid increase in the number of cellular and other portable communication device users.

One primary concern that has emerged over the use of portable electronic devices, and particularly cellular phones and the like, is the effect of radio emissions from cellular and wireless telephones that use radio band frequencies (RF) as a communication medium. Although no direct negative effects have yet been proven to be associated with RF cellular telephone, many users have become concerned and would welcome an alternative to the conventional RF devices.

Another concern associated with the use of portable communication devices such as cellular phones is the danger posed by users who use hand-held devices while operating a vehicle or other machinery. In such circumstances, a driver using a hand-held cellular telephone while driving typically drives with only one hand on the steering wheel to control the automobile. Use of only one hand results in decreased control of the vehicle and slower reaction times of the driver. To reduce the number of accidents caused by drivers using hand-held telephones, many governments, including California and Virginia, have discussed implementing legislation to prohibit the use of hand-held cellular telephones while driving or to require the use of a “hands free” adapter with all hand-held cellular phones while driving. At least one state, New York, has passed legislation prohibiting the use of a hand-held cellular phone while operating a motor vehicle. This safety concern is being addressed in other countries as well. For example, South Korea has now made it illegal to operate a hand-held cellular telephone while driving.

One solution to the problems associated with hand-held cellular telephones has been the use of a wire-type headset adapter, which connects to a traditional hand-held cellular telephone through a wire that attaches to a jack on the cellular phone. The headset includes an earpiece speaker and a microphone to allow the user to hear incoming signals and to communicate outgoing messages. Such wire-type headsets pose several problems. First, the wire-type headset often uses an earpiece speaker that fits into the ear canal of a user. A microphone is connected on the wire that connects the earpiece to the hand-held device. Without much support holding the earpiece speaker in the user's ear, the earpiece speaker can easily be dislodged, particularly if the wire connecting the earpiece speaker to the hand-held phone is moved. In addition, the placement of the microphone on the wire often places the microphone at an uncomfortable position for the user, so that the microphone does not receive all of the words spoken by the user. Ear cuffs and microphone boom supports are often used to overcome these deficiencies in the traditional hands-free configuration. However, ear cuffs and microphone booms tend to be cumbersome and can become tangled with the wire that connects to the hand-held device.

Moreover, often a user will not attach a headset to his hand-held telephone unless he anticipates making a call while driving. However, if a driver fails to anticipate that he will receive a call while driving, he may not have the wire-type headset attached to the hand-held device when a call is received. Therefore, he will have to attach the headset to the phone, possibly while driving, to take a call or to place a call.

In addition, most conventional solutions to the problems associated with hand-held cellular telephones have involved the use of low power radio frequency (RF) devices, which, as discussed above, may expose users to long-term health risks. Those solutions that have used infrared wavelengths have only been used for single direction transmission.

### SUMMARY OF THE INVENTION

Accordingly, the present invention is directed to an infrared full-duplex wireless headset that substantially obviates one or more of the problems due to limitations and disadvantages of the related art.

An object of the present invention is to provide a wireless device for full-duplex communications between a user and various electronic devices such as, but not limited to, cellular phones, landline phones, and computers.

Another object of the present invention is to provide a “hands-free” communication device that is useful whenever mobile or remote communication with electronic equipment is desired.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a full duplex infrared communication system includes a base unit for connecting to a telephone, the base unit including a transmitter for transmitting first infrared signals on a first infrared wavelength and a receiver for receiving second infrared signals on a second infrared wavelength; and a headset including a speaker, a microphone, and a receiver for receiving the first infrared signals from the base unit on the first wavelength and a transmitter for transmitting second infrared signals to the base unit on the second wavelength.

In another aspect of the present invention, a full duplex infrared communication system includes: a base unit for connecting to an electronic device, the base unit including a transmitter for transmitting first infrared signals on a first infrared wavelength and a receiver for receiving second infrared signals on a second infrared wavelength; and a remote unit including a receiver for receiving the first infrared signals on the first wavelength and a transmitter for transmitting second infrared signals on the second wavelength.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic illustration of a full duplex infrared communication system according to the present invention.

FIG. 2 is a diagram illustrating an embodiment of the present invention for use with a portable telephone.

FIG. 3 is a block diagram illustrating the components of a base according to the present invention.

FIG. 4 is a block diagram illustrating the components of a remote unit according to the present invention.

### DETAILED DESCRIPTION OF THE PREFERRED EMBODIMENTS

Reference will now be made in detail to the preferred embodiment of the present invention, example of which is illustrated in the accompanying drawings.

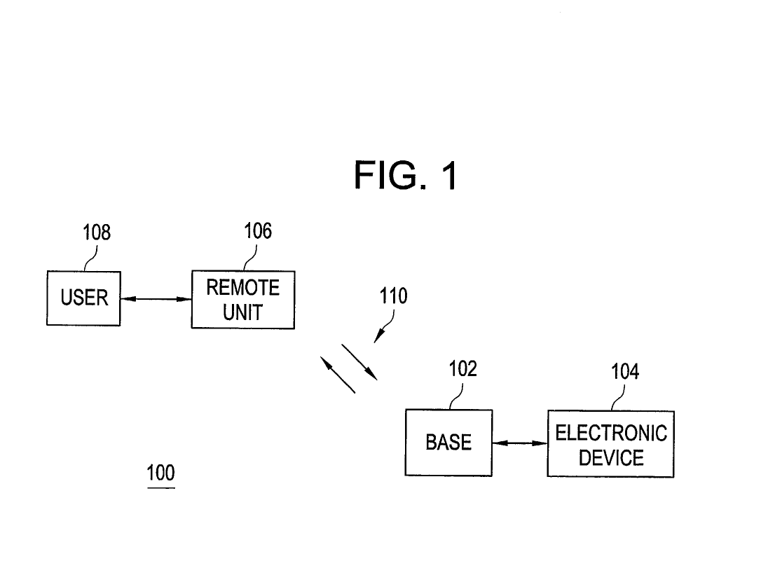

The device of the present invention is intended to be used with a conventional portable electronic device, such as a cellular telephone or portable computer. As shown schematically in FIG. 1, the system 100 includes a base 102 that interfaces with the electronic device 104 and a remote unit 106 that allows the user 108 to interface with the electronic device 104 at a distance away from the electronic device 104 and the base 102. For example, for use with a cellular telephone, the system of the present invention includes a base that electronically communicates with a hand-held cellular telephone and a remote unit that includes a speaker that would allow the user to hear the voice signal transmitted from the hand-held cellular telephone and a microphone that would allow the user to communicate back to the hand-held cellular telephone via the base. The remote unit 106 and the base 102 communicate with one another via full duplex infrared channels 110.

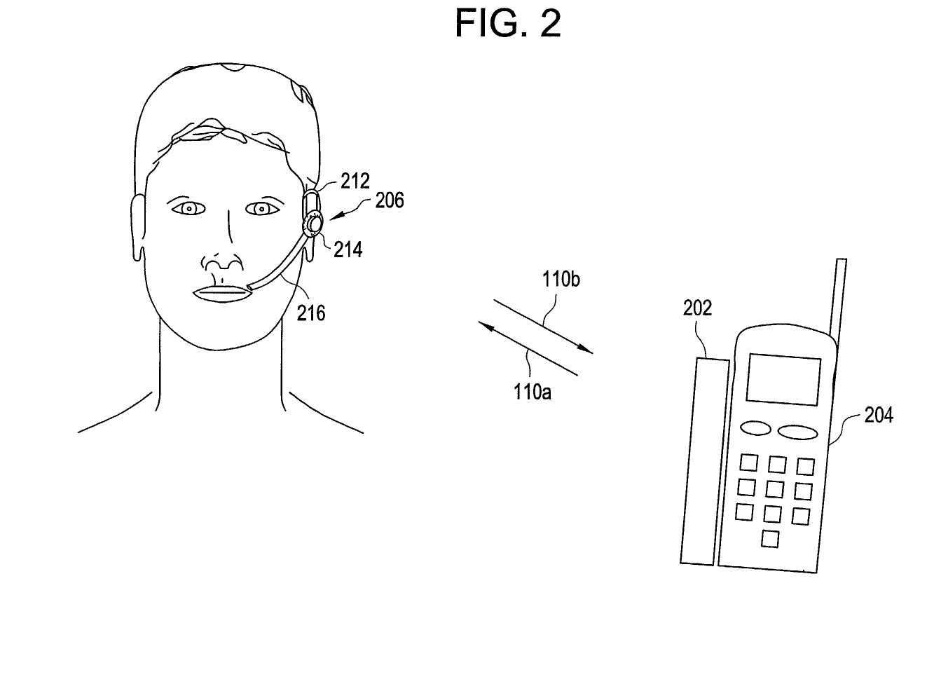

An example of one configuration of such system for use with a portable telephone is shown in FIG. 2. As shown in FIG. 2, a base 202 interfaces with a hand-held telephone 204. The base 202 is preferably smaller than the hand-held phone, although such relative size is not required. The base 202 electronically connects to the hand-held phone through a standard connection port, or jack (not shown). Conventional cellular telephones typically have a jack for connecting a wired hands-free device. Such jack may be used to connect the base of the present system. The base 202 may take any shape or design appropriate for the environment in which it is used. For example, to be conveniently used with a hand-held phone, the base unit may attach to the hand-held telephone. The base adapter electronically communicates with the electronic device. In the case of telephones, for example, the base adapter plugs into a headset jack of a telephone so equipped. The telephone may be either a landline telephone or a cellular telephone, and the base may be specifically configured to plug into a specific type of jack. In the case of cellular telephone, the base is a small box that plugs into the headset port of the telephone. Preferably, the base adapter has small dimensions, smaller than the telephone to which it connects.

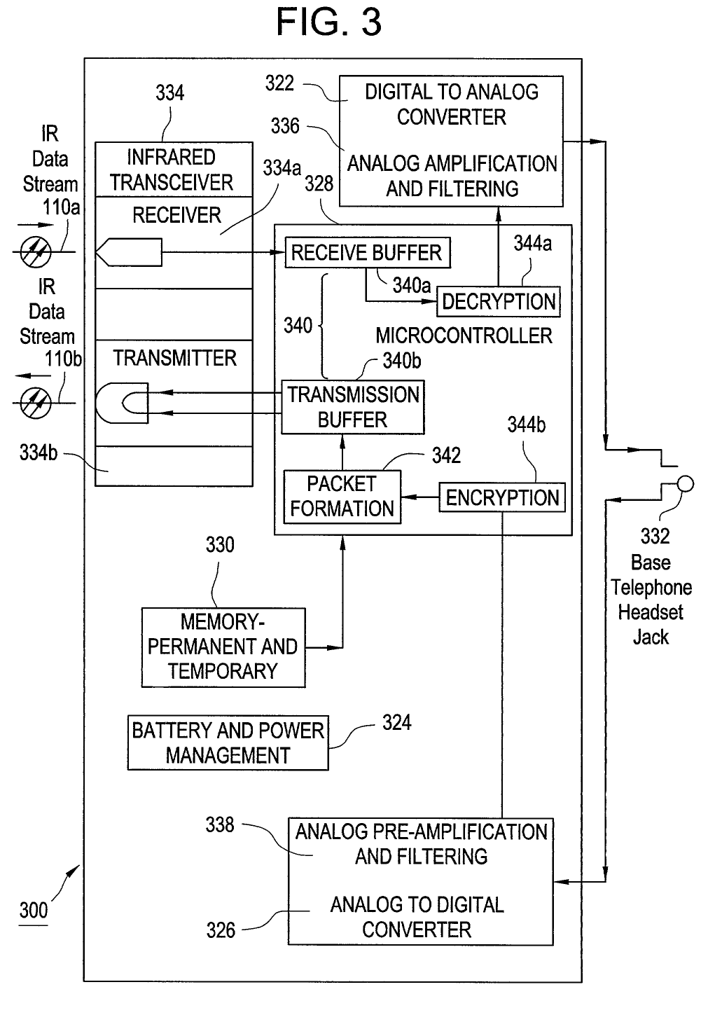

For hands-free communication with a portable telephone including cellular, portable, and landline telephones, the preferred embodiment of the present invention has a remote unit that includes a headset having a speaker and a microphone. The headset my have any of a plurality of configurations, including, but not limited to, headband type, an ear loop or earbud, as shown in FIG. 3. It is intended that the headset have an integrated microphone and earpiece. The integrated microphone may have any of plurality of configurations including a wire microphone or boom microphone. Similarly, the earpiece may have any of a plurality of different physical configurations such as an earbud or an earpiece with an ear-loop support. In one embodiment for use with a portable telephone, the remote unit, or headset, includes an earbud earpiece with a boom microphone. In the headset remote unit, earpiece supports are made of semi-rigid, cushioned materials to provide maximum comfort to the user. For the purposes of illustration, an ear loop with boom microphone is described and shown in FIG. 2.

As shown in FIG. 2, the system of the present invention for use with a portable telephone 204 includes a headset remote unit 206 and a base unit 202. In order to use the system with a portable telephone 204, the remote unit 206 includes a speaker 214, a microphone 216, and electronic processing circuitry (not shown). The electronic processing circuitry converts analog voice signals from the microphone 216 to digital data and transmits the digital data to the base 202 on a first infrared wavelength. The base 202 is electrically connected to the portable telephone 204. The base unit 202 receives the digital data signal on the first infrared wavelength 110a to analog or digital data, depending on the type of signal used by the portable phone, and transfers the received signal to the portable phone through the electrical connection between the base 202 and the portable telephone.

Similarly, signals from the portable telephone 204 are transmitted to the base 206. The base 206 converts the signals from the portable telephone 204 to digital data signal on an infrared signal having a second wavelength 110b. The electronic circuitry of the headset remote unit 206 converts the received signal to an analog signal and provides the signal to the speaker 214.

If the system of the present invention is to be used with other electronic devices, the remote unit should be appropriately configured to interface with the other electronic device. For example, if the electronic device is a computer, then an appropriate interface could be a graphical user interface or a keyboard and screen. However, the operation of the device is not dependent on a particular piece of application software. The device is intended to work just as any microphone/speaker system would work on any computer. The configurations of this system are unlimited. In any of the physical configurations, the remote unit will perform the same function. That function is to receive from, and transmit to, the base digitally encoded infrared data representing the control signals (Dual-Tone-Multi-Frequency (DTMF), dial tone, etc.) and voice/data. If the electronic device is configured to respond to voice activated commands or if the base is configured to convert voice commands to electronic control signals, the remote unit, particularly in the headset configuration, can be used to transmit voice commands to control the electronic device.

As shown in FIG. 3, the base 300 preferably includes a connector to the host device 322, a battery with power management circuitry 324, analog-to-digital (A/D) conversion circuitry 326, a micro-controller 328 with digital signal processor (DSP) capability, program memory 330 including permanent and random access memory, digital-to-analog (D/A) conversion circuitry 332, and infrared transceiver circuitry 334. As shown in FIG. 3, in the preferred embodiment, the base 300 also includes amplification and conversion circuitry 336, pre-amplification and filtering circuitry 338. The amplification circuitry may include automatic gain control. The infrared transceiver circuitry 334 includes a receiver 334a and a transmitter 334b, respectively receiving a first infrared wavelength 110a and transmitting on a second infrared wavelength 110b. Preferably, the microcontroller 328 includes buffering 340, including receive and transmit buffers 340a and 340b, coding circuitry, firware or software program 342, for example packet formation, and decryption and encryption circuitry, firmware or software program 344a and 344b. The battery 324 of the base may be non-rechargeable or may be rechargeable. If the battery 324 is rechargeable, it may be recharged using power from the electronic device to which it connects or may require a separate charging stand.

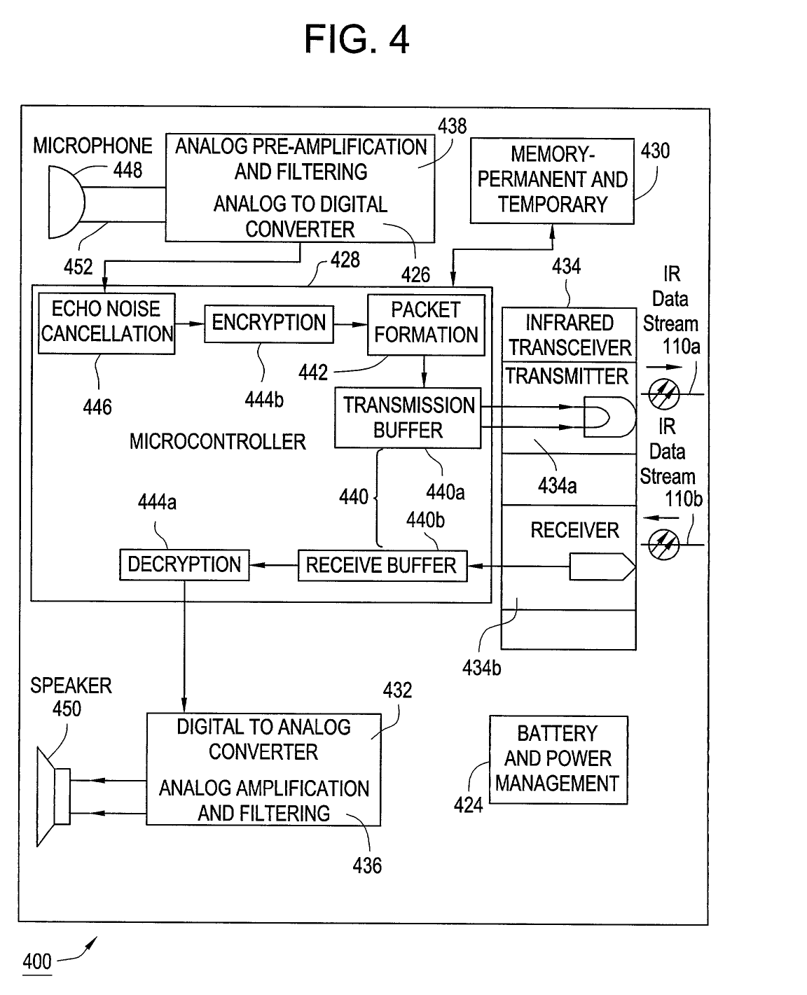

As shown in FIG. 4, the remote unit 400 preferably includes a battery with power management circuitry 424, a directional microphone 448, a speaker 450, A/D conversion circuitry 426, a micro-controller 428 with DSP capability, program memory 430, including permanent and random access memory, D/A conversion circuitry 432, and infrared transceiver circuitry 434. As shown in FIG. 4, in the preferred embodiment, the remote unit 400 also includes amplification and conversion circuitry 436 and pre-amplification and filtering circuitry 438. The amplification circuitry may include automatic gain control. The infrared transceiver circuitry 434 includes a transmitter 434a and a receiver 434b, respectively transmitting on a first infrared wavelength 110a and receiving on a second infrared wavelength 110b. Preferably, the microcontroller 428 includes buffering 440, including receive and transmit buffers 440a and 440b, coding circuitry, firmware or software program 442, for example packet formation, decryption and encryption circuitry, firmware or software program 444a and 444b, and echo cancellation circuitry 446.

Preferably, many components are common between the remote unit and the base. Specifically these components are the battery with power management circuitry, A/D conversion circuitry, a micro-controller with DSP capability, program memory, random access memory, D/A conversion circuitry, and infrared transceiver circuitry.

Transmit and receive infrared signals that are exchanged between the remote unit and the base will be at two separate infrared wavelengths 110a and 110b in order to promote full-duplex operation. Because of the use of two separate infrared wavelengths for the receive and transmit paths between the remote unit and the base, full-duplex communication can be achieved without any physical interference, or cross-talk, between the paths. Thus, as the remote unit is transmitting to the base, the base can simultaneously transmit to the remote unit without loss of data. The control programs for both the remote unit and the base are similar.

Communication in the context of a cellular telephone device will be described as an example of the operation of the system of the present invention with reference to FIGS. 3 and 4. In this example the remote unit is a headset, as shown in FIG. 2. Referring to FIG. 3, the headset remote unit 300 converts an analog microphone signal 452 into encrypted digital data in the encryption circuitry 444b. The encrypted digital data is formed into packets in the coding circuitry 442 of the microcontroller 428 and transmitted via a first infrared wavelength data path 110a to the base 300 (FIG. 3). The microcontroller 328 of the base 300 receives the infrared packets, decrypts the infrared data packets, and the information in the packets into a standard digital bit-stream that is accepted by the D/A converter 332 of the base 300. The output of the D/A converter 332 is appropriately amplified and placed at the headset jack 322 of the host telephone (not shown). The same process is applied for voice data in the receive path. The host telephone (not shown) places an analog signal at the receive connection of the headset jack 322, the base A/D converter 326 and microcontroller having an encryption circuit and packet formation (coding) circuitry converts the data into a format that is transmitted to the headset remote unit (400) via a second infrared wavelength data path 110b. The headset remote unit 400 receives this data at the receiver 434b, provides decryption by the decryption circuitry 444a, converts the digital signal to an analog signal in the D/A converter 432, amplifies the signal in the amplification and filtering circuitry 436, and places the signal at the headset speaker 450. With proper control within the programs that operate the various circuitry within the system, the user perceives full-duplex operation of the transmit and receive audio or other data.

The small package size and weight of both the base 300 and the remote unit 400 may be achieved through the use of Multi-Chip-Module (MCM) fabrication and assembly technologies

The present system is capable of operating in environments with multiple system units operating without interference among the units. The system can also be adapted to allow multiple electronic devices to communicate with one or multiple remote units. For example, the base can be modified from a single connector for a single electronic device to multiple connectors to a plurality of electronic devices. Such connection would allow connection of a single base to multiple computers or multiple audio/video devices. Thus, the device of the present invention may replace remote controls as currently used with televisions, stereos, garage door openers, and various household power and lighting controls. For example, by assigning unique verbal names or “addresses” to each base, a single remote unit, such as a headset, may receive multiple signals within the system's functional environment. Such configuration would allow a user to connect with many devices in a manner similar to data networks. When functioning in this type of environment, the remote unit buffers the data signals in such a manner as to insure that audio/voice/data from one device does not interfere with audio/voice/data from another device on the network system. When multiple devices communicate with the remote unit, there may be a single base unit, as described above, or multiple base units configured to operate with respective electronic devices and a common remote unit.

In addition, by using a remote unit with a speaker and microphone, similar to the remote unit described with respect to FIG. 2, the present invention is useful in providing verbal commands to multiple pieces of electronic equipment. Speech recognition capability can be incorporated into the base such that “interactive programming” may be accomplished through voice commands from the remote unit microphone. This would allow the user to enable or disable reception or transmission of audio from an individual base in a multiple device environment.

Nothing in this description requires that the base unit be a separate unit. As components size allows, the base may be physically incorporated as part of the circuit design of an electronic device. Thus, the base functionality may be integral to the electronic device design. Application Specific Integrated Circuit (ASIC) technology may be applied to the design of any of the components of the present system to reduce size and cost.

By providing dual infrared digital transmission bands with background (noise) suppression, of ambient infrared light. Suppression is accomplished by measuring background infrared and using that measured level to automatically control the actual signal gains. The infrared signals between the base and remote units do not need direct line of sight between the base and the remote unit. For example, if a direct line of sight is not available, reflection of the infrared signals in the surrounding environment is sufficient to convey signals between the base and the remote unit and between the remote unit and the base.

It will be apparent to those skilled in the art that various modifications and variation can be made in the present invention without departing from the spirit or scope of the invention. Thus, it is intended that the present invention cover the modifications and variations of this-invention provided they come within the scope of the appended claims and their equivalents.

What is claimed is:

1. A full duplex infrared communication system, comprising:
a base unit for connecting to a telephone, the base unit including a transmitter for transmitting first infrared signals on a first infrared wavelength and a receiver for receiving second infrared signals on a second infrared wavelength; and
a headset including a speaker, a microphone, and a receiver for receiving the first infrared signals from the base unit on the first wavelength and a transmitter for transmitting second infrared signals to the base unit on the second wavelength.

2. The full duplex infrared communication system of claim 1, wherein the base unit further includes a connector that fits into a jack of the telephone.

3. The full duplex infrared communication system of claim 1, wherein the headset unit includes an earpiece and a headband,

4. The full duplex infrared communication system of claim 1, wherein the headset includes an earpiece that fits into a human ear and an ear loop support.

5. The full duplex infrared communication system of claim 1, wherein the base unit further comprises:
an analog to digital converter;
a microcontroller;
memory;
a digital to analog converter; and
a battery.

6. The full duplex infrared communication system of claim 5, wherein the microcontroller includes a coder and an encryption circuit.

7. The full duplex infrared communication system of claim 6, wherein the microcontroller further includes a transmission buffer and a receive buffer.

8. The full duplex infrared communication system of claim 5, wherein the microcontroller includes a firmware for coding a communications signal.

9. The full duplex infrared communication system of claim 5, wherein the microcontroller includes a software ware for coding a communications signal.

10. The full duplex infrared communication system of claim 1, wherein the remote unit further comprises:
an analog to digital converter;
a microcontroller;
memory;
a digital to analog converter; and
a battery.

11. The full duplex infrared communication system of claim 10, wherein the microcontroller includes a coder and an encryption circuit.

12. The full duplex infrared communication system of claim 11, wherein the microcontroller further includes a transmission buffer and a receive buffer.

13. The full duplex infrared communication system of claim 10, wherein the microcontroller includes a firmware for coding a communications signal.

14. The full duplex infrared communication system of claim 10, wherein the microcontroller includes a software for coding a communications signal.

15. A full duplex infrared communication system, comprising:
a base unit for connecting to an electronic device, the base unit including a transmitter for transmitting first infrared signals on a first infrared wavelength and a receiver for receiving second infrared signals on a second infrared wavelength; and
a remote unit including a receiver for receiving the first infrared signals on the first wavelength and a transmitter for transmitting second infrared signals on the second wavelength.

16. The full duplex infrared communication system of claim 15, wherein the base unit further includes a connector that fits into a jack of the telephone.

17. The full duplex infrared communication system of claim 15, wherein the headset unit includes an earpiece and a headband,

18. The full duplex infrared communication system of claim 15, wherein the headset includes an earpiece that fits into a human ear and an ear loop support.

19. The full duplex infrared communication system of claim 15, wherein the base unit further comprises:
an analog to digital converter;
a microcontroller;
memory;
a digital to analog converter; and
a battery.

20. The full duplex infrared communication system of claim 19, wherein the microcontroller includes a coder and an encryption circuit.

21. The full duplex infrared communication system of claim 20, wherein the microcontroller further includes a transmission buffer and a receive buffer.

22. The full duplex infrared communication system of claim 19, wherein the microcontroller includes a firmware for coding a communications signal.

23. The full duplex infrared communication system of claim 19, wherein the microcontroller includes a software ware for coding a communications signal.

24. The full duplex infrared communication system of claim 15, wherein the remote unit further comprises:
an analog to digital converter;
a microcontroller;
memory;
a digital to analog converter; and
a battery.

25. The full duplex infrared communication system of claim 24, wherein the microcontroller includes a coder and an encryption circuit.

26. The full duplex infrared communication system of claim 25, wherein the microcontroller further includes a transmission buffer and a receive buffer.

27. The full duplex infrared communication system of claim 24, wherein the microcontroller includes a firmware for coding a communications signal.

28. The full duplex infrared communication system of claim 24, wherein the microcontroller includes a software for coding a communications signal.
